(19) United States
(12) Patent Application Publication
(10) Pub. No.: US 2025/0293255 A1
(43) Pub. Date: Sep. 18, 2025

(54) POSITIVE ELECTRODE FOR ALL-SOLID-STATE BATTERY, AND ALL-SOLID-STATE BATTERY COMPRISING SAME

(71) Applicant: LG Energy Solution, Ltd., Seoul (KR)

(72) Inventors: Choonghyeon Lee, Daejeon (KR); Taegon Kim, Daejeon (KR); Ki Tae Kim, Daejeon (KR); Myeongsoo Kim, Daejeon (KR)

(21) Appl. No.: 18/858,672

(22) PCT Filed: Dec. 13, 2023
(86) PCT No.: PCT/KR2023/095107

§ 371 Date: Oct. 21, 2024

(30) Foreign Application Priority Data
Dec. 27, 2022 (KR) 10-2022-0185956
Jul. 21, 2023 (KR) 10-2023-0095018

(51) Int. Cl. H01M 4/62; C01B 32/20; H01M 4/525

(52) U.S. Cl. CPC H01M 4/62; C01B 32/20; H01M 4/525; H01M 4/625; C01P 2006/10; C01P 2006/12; C01P 2006/40

(57) ABSTRACT

A positive electrode for an all-solid-state battery having adjusted properties of a composition related to a carbon-based conductive material, and an all-solid-state battery including the same is provided. The positive electrode for an all-solid-state battery includes a positive-electrode active material, a carbon-based conductive material, a binder, and an inorganic solid electrolyte, wherein the carbon-based conductive material is a fibrous carbon-based conductive material having a length from 1 μm to 100 μm. The fibrous carbon-based conductive material can improve the initial discharge efficiency of the all-solid-state battery when mixed with the positive-electrode active material in an appropriate ratio, as well as improve the capacity retention rate at a high-rate discharge above 0.5 C.

The present application is a National Phase entry pursuant to 35 U.S.C. § 371 of International Application No. PCT/KR2023/095107 filed on Dec. 13, 2023, and claims priority to and the benefit of Korean Patent Application No. 10-2022-0185956, filed Dec. 27, 2022, and Korean Patent Application No. 10-2023-0095018, filed Jul. 21, 2023, the disclosures of which are incorporated herein by reference in their entirety.

### TECHNICAL FIELD

The present invention relates to a positive electrode for an all-solid-state battery and an all-solid-state battery comprising the same. More particularly, the present invention relates to a positive electrode for an all-solid-state battery and an all-solid-state battery comprising the same, in which the properties of composition related to carbon-based conductive material are adjusted.

### BACKGROUND ART

Various batteries are being researched to overcome the limitations of current lithium secondary batteries in terms of capacity, safety, power output, enlargement, and miniaturization.

For example, metal-air batteries, which have a very large theoretical capacity compared to lithium secondary batteries; all-solid-state batteries, which have no explosion risk; supercapacitors in terms of power output; NaS batteries or redox flow batteries (RFBs) in terms of enlargement; and thin film batteries in terms of miniaturization, are being continuously researched in academia and industry.

The all-solid-state battery refers to a battery in which a liquid electrolyte used in conventional lithium secondary batteries is replaced by a solid one, and since no flammable solvent is used in the battery, there is no possibility of ignition or explosion due to the decomposition reaction of the conventional electrolyte, which can greatly improve safety. In addition, since Li metal or Li alloy can be used as a negative electrode material, it has the advantage of dramatically improving the energy density per mass and volume of the battery.

In particular, among the solid electrolyte types for all-solid-state batteries, inorganic solid electrolytes can be categorized into sulfide-based and oxide-based. Currently, sulfide-based solid electrolytes are the most technologically advanced solid electrolytes, and they have the advantages of high ionic conductivity and a wide temperature coverage compared to other solid electrolytes. Unlike conventional lithium secondary batteries, as all-solid-state batteries containing a sulfide-based solid electrolyte do not conduct Li ions by a liquid electrolyte. When fabricating a positive electrode, a small-diameter sulfide-based solid electrolyte must be added inside the positive electrode to increase the contact interface between the positive-electrode active material and the electrolyte to increase the conductivity of Li ions. In addition, a conductive material must be added to conduct electrons between the active material and the electrolyte and other battery elements in the positive electrode. However, degradation of the sulfide-based solid electrolyte may occur due to excessive electron transfer during charge and discharge.

Accordingly, the present inventors identified property factors of carbon-based conductive materials that can be used for all-solid-state batteries, especially for a positive electrode of inorganic all-solid-state batteries, and studied how to improve the performance of all-solid-state batteries centered on carbon-based conductive materials, and completed the present invention.

### PATENT DOCUMENT

(Patent Document 1) Korean Laid-Open Publication No. 10-2022-0028933

### SUMMARY OF THE INVENTION

To improve the performance of a positive electrode for an all-solid-state battery, a positive electrode for all-solid-state batteries with adjusted properties of a composition related to carbon-based conductive material is provided, along with an all-solid-state battery comprising the positive electrode.

According to a first aspect of the present invention, the present invention provides a positive electrode for an all-solid-state battery, comprising: a positive-electrode active material, a carbon-based conductive material, and an inorganic solid electrolyte.

In an embodiment of the present invention, the carbon-based conductive material is a fibrous carbon-based conductive material having a length from 1 μm to 100 μm.

In an embodiment of the present invention, the carbon-based conductive material is a fibrous carbon-based conductive material having a diameter from 50 nm to 500 nm.

In an embodiment of the present invention, a BET specific surface area of the carbon-based conductive material is from 1 m²/g to 20 m²/g.

In an embodiment of the present invention, a powder resistivity of the carbon-based conductive material is equal to or less than 0.025 ohm-cm under 196 MPa pressure.

In an embodiment of the present invention, the carbon-based conductive material has a density from 1 g/cm³ to 5 g/cm³.

In an embodiment of the present invention, the carbon-based conductive material has an A value from 100 to 500.

In an embodiment of the present invention, the carbon-based conductive material has a difference of 0.3 to 0.7 in I_{D}/I_{G} values before and after graphitization in a Raman spectral analysis.

In an embodiment of the present invention, the carbon-based conductive material has a difference of 10 to 50 in degree of graphitization (DoG) values before and after graphitization in an XRD analysis.

In an embodiment of the present invention, the positive electrode has a B value from 5 to 50.

In an embodiment of the present invention, the positive-electrode active material is selected from a group consisting of: LiCoO₂, LiNiO₂, LiMnO₂, Li₂MnO₃, LiMn₂O₄, Li(NiₐCo_{b}Mn_{c})O₂ (0<a<1, 0<b<1, 0<c<1, a+b+c=1), LiN_{1-y}Co_{y}O₂ (0<y<1), LiCo_{1-y}Mn_{y}O₂ (0<y<1), LiNi_{1-y}Mn_{y}O₂ (0<y<1), Li(NiₐCo_{b}Mn_{c})O₄ (0<a<2, 0<b<2, 0<c<2, a+b+c=2), LiMn_{2-z}Ni_{z}O₄ (0<z<2), LiMn_{2-z}Co_{z}O₄ (0<z<2), and combinations thereof.

In fabricating a positive electrode for an all-solid-state battery, performance of a positive electrode for an all-solid-state battery can be improved by adjusting properties of a composition of a carbon-based conductive material within a certain range. Specifically, a fibrous carbon-based conductive material with certain properties can improve the initial discharge efficiency of an all-solid-state battery when mixed with a positive-electrode active material in an appropriate ratio, as well as improving the capacity retention rate at high-rate discharges above 0.5 C.

### BRIEF DESCRIPTION OF THE DRAWING

FIG. 1 is a graph depicting the capacity retention results of the first through third charge/discharge tests according to experimental examples.

### DETAILED DESCRIPTION

All of the embodiments provided by the present invention can be achieved by the following description. It should be understood that the following description describes a preferred embodiment of the present invention and is not necessarily limited to the present invention.

For any property described in this disclosure, if the measurement conditions and methods are not specifically stated, the property shall be measured in accordance with the measurement conditions and methods commonly used by one of ordinary skill in the art.

An aspect of the present invention provides a positive electrode for an all-solid-state battery comprising a positive-electrode active material, a conductive material, and an inorganic solid electrolyte. According to an embodiment of the present invention, the positive electrode for an all-solid-state battery further comprises a binder. The conductive material is a carbon-based conductive material having carbon as a major component, which is commonly used as a component of conductive materials in the relevant technical field. Even if there is no specific reference to the material of the conductive material in this specification, it shall be interpreted as a carbon-based conductive material. The positive electrode can improve the performance of an all-solid-state battery, particularly the initial discharge efficiency and the capacity retention rate at high-rate discharge, by using a fibrous conductive material with certain properties mixed with a positive-electrode active material in an appropriate ratio.

In a positive electrode according to an embodiment of the present invention, the conductive material includes a fibrous conductive material. In the present disclosure, “fibrous conductive material” means a conductive material with a length-to-diameter ratio of 5 or more for a cylindrical shape.

According to an embodiment of the present invention, the fibrous conductive material has a length from 1 μm to 100 μm. Specifically, the length of the fibrous conductive material may be 1 μm or more, 2 μm or more, 3 μm or more, 4 μm or more, 5 μm or more, and may be 100 μm or less, 90 μm or less, 80 μm or less, 70 μm or less, 60 μm or less, 50 μm or less, 40 μm or less, 30 μm or less, 20 μm or less, and may be from 1 μm to 100 μm, 3 μm to 60 μm, or 5 μm to 20 μm. When the length of the fibrous conductive material is adjusted within the aforementioned range, it may be advantageous for improving the performance of the all-solid-state battery by forming an appropriate conductive networking between the active materials.

According to an embodiment of the present invention, the fibrous conductive material has a diameter from 50 nm to 500 nm. The diameter is measured concerning the circular cross-section of the fibrous conductive material. Specifically, the diameter of the fibrous conductive material may be 50 nm or more, 60 nm or more, 70 nm or more, 80 nm or more, 90 nm or more, or 100 nm or more, and may be 500 nm or less or 470 nm or less, 440 nm or less, 410 nm or less, 380 nm or less, or 350 nm or less, and may be from 50 nm to 500 nm, 70 nm to 410 nm, or 100 nm to 350 nm. When the diameter of the fibrous conductive material is adjusted within the aforementioned range, it may be advantageous to improve the performance of the all-solid-state battery by securing a sufficient amount of active material while allowing the conductive material to be appropriately disposed therebetween.

According to an embodiment of the present invention, the fibrous conductive material has an aspect ratio of 20 or more. The aspect ratio is defined as the value obtained by dividing the length of the cylindrical shape in the fibrous conductive material by the diameter of the circle. Specifically, the aspect ratio of the fibrous conductive material may be 20 or more, 22 or more, 24 or more, 26 or more, 28 or more, 30 or more, 32 or more, 34 or more, 36 or more, 38 or more, or 40 or more. If the fibrous conductive material can be effectively disposed between the active materials, the upper limit of the aspect ratio of the fibrous conductive material is not particularly limited. For example, the aspect ratio of the fibrous conductive material may be 100 or less. When the aspect ratio of the fibrous conductive material is adjusted within the aforementioned range, it may be advantageous to improve the performance of the all-solid-state battery, such as by facilitating effective arrangement the conductive material between the active materials.

According to an embodiment of the present invention, the conductive material has a BET specific surface area from 1 m²/g to 20 m²/g. The BET specific surface area is a specific surface area measured by the BET method and can be calculated, for example, from the amount of mass gas adsorption at a liquid nitrogen temperature (77 K) using the BELSORP-mini II of BEL Japan. Specifically, the BET specific surface area of the conductive material may be 1 m²/g or more, 2 m²/g or more, 3 m²/g or more, 4 m²/g or more, or 5 m²/g or more, and may be 20 m²/g or less, 19 m²/g or less, 18 m²/g or less, 17 m²/g or less, 16 m²/g or less, or 15 m²/g or less, and may be from 1 m²/g to 20 m²/g, 3 m²/g to 17 m²/g, 5 m²/g to 15 m²/g. When the BET specific surface area of the conductive material is adjusted within the aforementioned range, it may be advantageous for improving the performance of the all-solid-state battery by the effect that the conductive material efficiently contacts the active material relative to the input amount.

According to an embodiment of the present invention, the conductive material has a powder resistivity of 0.025 ohm-cm or less under a pressure of 196 MPa. The conductivity of the conductive material can be measured as the powder resistivity of the conductive material powder, and the powder resistivity can be measured using a powder resistivity meter equipped with a 4-pin probe while adjusting the pressure applied to the powder. For example, the powder resistivity may be measured by placing a certain amount of conductive material in the powder resistivity meter and continuously applying a force, and measuring the density measured as the particles are pressed, and measuring the powder resistivity with the 4-pin probe. The conductive material according to an embodiment of the present invention may have a decrease in powder resistivity as the pellet density increases, which means that the conductivity of the conductive material particles themselves improve as the degree of compression becomes stronger. Specifically, the powder resistivity of the conductive material may be 0.025 ohm-cm or less, 0.024 ohm-cm or less, 0.023 ohm-cm or less, 0.022 ohm-cm or less, 0.021 ohm-cm or less, 0.02 ohm-cm or less under a pressure of 196 MPa. The conductive material according to the present invention has low powder resistivity and excellent conductivity.

According to an embodiment of the present invention, the conductive material has a density of from 1 g/cm³ to 5 g/cm³. The density refers to the true density of the conductive material, which can be measured according to general methods known in the art. For example, the density may be measured using an AccuPycll-1340 instrument from Micromeritics. Specifically, the density of the conductive material may be 1 g/cm³ or more, 1.5 g/cm³ or more, or 2 g/cm³ or more, and may be 5 g/cm³ or less, 4.5 g/cm³ or less, 4 g/cm³ or less, 3.5 g/cm³ or less, 3 g/cm³ or less, or 2.5 g/cm³ or less, and may be from 1 g/cm³ to 5 g/cm³, 1.5 g/cm³ to 4 g/cm³, or 2 g/cm³ to 2.5 g/cm³. When the density of the conductive material is adjusted within the aforementioned range, it may be advantageous for improving the performance of the all-solid-state battery due to effects such as improving the functionality of the conductive material.

By confirming various properties related to the electrode material, the positive electrode for the all-solid-state battery can be advantageously formed to provide improved performance. Accordingly, an embodiment of the present invention defines a new parameter A with respect to the properties of the conductive material. The A value is determined by the following Equation 1.

$$A = specific surface area \times length \times density \qquad Equation 1$$

Here, the specific surface area is the BET specific surface area of the conductive material (m²/g), the length is the length of the conductive material (μm), and the density is the density of the conductive material (g/cm³). The length refers to the length of the conductive material, but in the case of a spherical shape, such as a particulate conductive material, it may refer to the diameter of the sphere. The factors determining the above A value, i.e., specific surface area, length, and density, are numerical values in accordance with the units described above, and therefore, the units of the A value are not specifically converted. According to an embodiment of the present invention, the conductive material has an A value from 100 to 500. Specifically, the A value of the conductive material may be 100 or more, 110 or more, 120 or more, 130 or more, 140 or more, or 150 or more, and may be 500 or less, 470 or less, 440 or less, 410 or less, 380 or less, or 350 or less, and may be from 100 to 500, 130 to 410, or 150 to 350. The A value of the conductive material may be one criterion by which the conductive material can realize functionality at the positive electrode of an all-solid-state battery. In the case of linear conductive materials, such as commonly known carbon nanofibers, the long fibers of the conductive material interfaces with the active material and electrolyte particles in the fiber direction, and in the case of particle-like conductive materials, such as carbon black, each particle interfaces with the active material and electrolyte. In these cases, the A value is a variable representing a shape of the conductive material, and means a shape that includes a hollow structure on a surface of the conductive material. According to Equation 1 above, when the conductive material used is linear, the longer the fiber length and the higher the density, the higher the A value. The longer the length of a single fiber, the smaller the contact between the conductive material fibers or particles, and the more difficult it is for them to aggregate, increasing the dispersion of the conductive material in the positive electrode. When the A value of the conductive material is adjusted within the aforementioned range, the conductive material can realize sufficient functionality in the positive electrode, which can be advantageous for improving the performance of an all-solid-state battery.

According to an embodiment of the present invention, the carbon-based conductive material has a difference from 0.3 to 0.7 between the I_{D}/I_{G} values before and after graphitization in a Raman spectral analysis. The method of graphitization and measurement of the I_{D}/I_{G} value follows general methods known in the art, and more particularly according to the method described in the following embodiment. The difference between the above I_{D}/I_{G} values is expressed as the higher of the I_{D}/I_{G} values before and after graphitization minus the lower value. Specifically, the difference between the I_{D}/I_{G} values before and after graphitization of the carbon-based conductive material may be 0.3 or more, 0.35 or more, 0.4 or more, or 0.45 or more, and may be 0.7 or less, 0.65 or less, 0.6 or less, 0.55 or less, or 0.5 or less, and may be from 0.3 to 0.7, 0.35 to 0.65, 0.4 to 0.6. The carbon-based conductive material undergoes a certain level of crystalline changes through graphitization, so that graphitized conductive materials can well complement positive electrode materials and electrolytes.

According to an embodiment of the present invention, the carbon-based conductive material has a difference from 10 to 50 between the degree of graphitization (DoG) values before and after graphitization in an XRD analysis. The method of graphitization method and measurement of the graphitization degree of graphitization (DoG) value follows general methods known in the art, and more particularly to the methods described in the following embodiments. The degree of graphitization (DoG) is an indicator to determine which material the crystalline surface of the sample is close to between the crystalline surface spacing of ideal graphite (3.354 Å) and the crystalline surface spacing of coal (3.440 Å). In the case of amorphous carbon with a wider spacing than the coal crystallite spacing, the DoG value is negative, and the closer it is to 100, the closer it is to fully ordered graphite. The difference in the DoG values represents the subtraction of the lower value from the higher value between the DoG values before and after graphitization. Specifically, the difference between the DoG values of the carbon-based conductive material before and after graphitization may be 10 or more, 15 or more, 20 or more, or 25 or more, and may be 50 or less, 45 or less, 40 or less, 35 or less, or 30 or less, and may be 10 to 50, 15 to 45, or 20 to 40. The carbon-based conductive material undergoes a certain level of crystalline form change through graphitization, allowing it to be well-suited for the positive electrode active material and electrolyte before graphitization.

The positive-electrode active material can be anything that can be used as the positive-electrode active material of a lithium secondary battery. For example, the positive-electrode active material may be a lithium transition metal oxide comprising one or more transition metals. In an embodiment of the present invention, the positive-electrode active material is selected from a group consisting of: LiCoO₂, LiNiO₂, LiMnO₂, Li₂MnO₃, LiMn₂O₄, Li(NiₐCo_{b}Mn_{c})O₂ (0<a<1, 0<b<1, 0<c<1, a+b+c=1), LiN_{1-y}Co_{y}O₂ (0<y<1), LiCo_{1-y}Mn_{y}O₂ (0<y<1), LiNi_{1-y}Mn_{y}O₂ (0<y<1), Li(NiₐCo_{b}Mn_{c})O₄ (0<a<2, 0<b<2, 0<c<2, a+b+c=2), LiMn_{2-z}Ni_{z}O₄ (0<z<2), and LiMn_{2-z}Co_{z}O₄ (0<z<2), and combinations thereof.

The binder binds the electrode components, such as the positive-electrode active material and the conductive material, and helps the electrode to have a stable internal structure. The solid electrolyte primarily used in one specific example of the present invention is a sulfide-based solid electrolyte, which is sensitive to moisture and tends to generate H₂S gas upon contact with moisture. Therefore, it is desirable to minimize moisture during electrode manufacturing. According to an embodiment of the present invention, the binder is an organic binder. The organic binder refers to a binder that is soluble or dispersible in an organic solvent, particularly N-methylpyrrolidone (NMP), and is distinguished from an aqueous binder which has water as the solvent or dispersant. Specifically, organic binders may be selected from a group consisting of: polyvinylidene fluoride (PVDF), polyvinylidene fluoride-hexafluoropropylene copolymer (PVDF-co-HFP), polyvinyl alcohol, starch, hydroxypropyl cellulose, regenerated cellulose, polyvinylpyrrolidone, polyimide, polyamideimide, polyethylene, polypropylene, ethylene-propylene-diene monomer (EPDM), sulfonated EPDM, styrene butadiene rubber, and fluorinated rubber, although not limited thereto.

When a dry method is used to combine electrode components such as positive-electrode active material and conductive material with a binder, a fiberizing binder may be used. The fiberizing binder extensively connects the components in the electrode in the form of fibers within the electrode structure, such that the basic structure of the electrode is maintained by the positive-electrode active material, the conductive material, and the binder alone. The fiberizing binder is not particularly limited as long as it is one commonly used in the relevant technical field. For example, the fiberizing binder may be polytetrafluoroethylene (PTFE). The fiberizing binder may be used combined with the organic binders described above.

In the all-solid-state battery, the solid electrolyte is not particularly limited as long as it is a solid electrolyte commonly used in the relevant technical field. According to an embodiment of the present invention, the solid electrolyte in the all-solid-state battery comprises an inorganic solid electrolyte, in which the inorganic solid electrolyte is a sulfide-based solid electrolyte, a halide-based solid electrolyte, an oxide-based solid electrolyte, or a combination thereof.

The sulfide-based solid electrolyte includes sulfur atoms among the electrolyte components, but is not limited to any particular component, and may include one or more of crystalline solid electrolytes, amorphous solid electrolytes (glassy solid electrolytes), and glass-ceramic solid electrolytes. Specific examples of the sulfide-based solid electrolytes include LPS-type sulfides containing sulfur and phosphorus, LPSCl-type sulfides (e.g., Li₆PS₅Cl), Li₄₋ₓGe₁₋ₓPₓS₄ (x is from 0.1 to 2, more specifically, x is ¾, ⅔), Li_{10±1}MP₂X₁₂ (M=Ge, Si, Sn, Al, X═S, Se), Li_{3.833}Sn_{0.833}As_{0.166}S₄, Li₄SnS₄, Li_{3.25}Ge_{0.25}P_{0.75}S₄, Li₂S—P₂S₅, B₂S₃—Li₂S, xLi₂S-(100-x)P₂S₅ (x is from 70 to 80), Li₂S—LiI—P₂S₅, Li₂S—LiI—Li₂O—P₂S₅, Li₂S—LiBr—P₂S₅, Li₂S—LiCl—P₂S₅, Li₂S—Li₂O—P₂S₅, Li₂S—Li₃PO₄—P₂S₅, Li₂S—P₂S₅—P₂O₅, Li₂S—P₂S₅—SiS₂, Li₂S—P₂S₅—SnS, Li₂S—P₂S₅—Al₂S₃, Li₂S—GeS₂, Li₂S—GeS₂—ZnS, Li₂S—SiS₂—Li₃N, Li₂S—SiS₂—LiI, Li₂S—B₂S₃—LiI, etc. although not limited thereto.

The halide-based solid electrolyte may include at least one of Li₃YCl₆ and Li₃YBr₆, although not limited thereto.

The oxide-based solid electrolyte may be suitably selected and used from LLT-based with a perovskite structure such as Li₃ₓLa_{2/3-x}TiO₃, LISICON such as Li₁₄Zn(GeO₄)₄, LATP-based such as Li_{1.3}Al_{0.3}Ti_{1.7}(PO₄)₃, LAGP-based such as (Li₁₊ₓGe₂₋ₓAlₓ(PO₄)₃), and phosphate-based such as LiPON, although not limited thereto.

The positive-electrode active material, conductive material, binder, and inorganic solid electrolyte composing the positive electrode for the all-solid-state battery may be introduced into the positive electrode in various ways and forms. It is possible to manufacture the positive electrode by mixing the positive-electrode active material, conductive material, binder, and inorganic solid electrolyte together, or initially forming the structure of the all-solid-state battery with the positive-electrode active material, conductive material, and binder, and then injecting and immobilizing the inorganic solid electrolyte.

The positive-electrode active material, conductive material and binder may also be granulated to first form the structure of an all-solid-state battery. The granules may be fabricated by methods commonly used in the relevant technical field, without limitation. For example, the granules may be fabricated by preparing a slurry and then spray drying. The active material, which is a particulate in a powder state, is introduced together with a binder and a conductive material to grow the granules to a certain size. According to an embodiment of the present invention, the granules are spherical particles comprising a positive-electrode active material, a binder and a solid electrolyte. Spherical does not mean fully spherical in the strict sense of the word, but is generally used as an umbrella concept to include particles with a rounded shape.

According to an embodiment of the present invention, the granules are spherical particles having a diameter of from 30 μm to 150 μm. Here, a spherical particle does not mean a perfectly spherical particle, and thus the diameter means the largest value of the distance from a point on any surface of the particle to a point on another surface. Specifically, the diameter of the granules may be 30 μm or more, 35 μm or more, 40 μm or more, 45 μm or more, or 50 μm or more, and may be 150 μm or less, 145 μm or less, 140 μm or less, 135 μm or less, 130 μm or less, 125 μm or less, or 120 μm or less, and may be 30 μm to 150 μm, 40 μm to 135 μm, or 50 μm to 120 μm. When the size of the granules is adjusted within the above range, an appropriate level of pores to accommodate the solid electrolyte can be secured when the active material layer is formed.

The positive-electrode active material, conductive material and binder are introduced into the positive electrode by adjusting the mixing ratio to a level at which the functionality of the conductive material and binder can be sufficiently controlled while including as much of the positive-electrode active material as possible to secure the capacity of the electrode. According to an embodiment of the present invention, the positive electrode includes 83 parts by weight to 99.8 parts by weight of the positive-electrode active material, 0.1 parts by weight to 10 parts by weight of the binder, and 0.01 parts by weight to 10 parts by weight of the conductive material, based on a total weight of 100 parts of the positive-electrode active material, binder, and conductive material. Specifically, the content of the positive-electrode active material may be 83 parts by weight or more, 84 parts by weight or more, 85 parts by weight or more, 86 parts by weight or more, 87 parts by weight or more, 88 parts by weight or more, 89 parts by weight or more, or 90 parts by weight or more, and may be 99.9 parts by weight or less, 99.8 parts by weight or less, 99.7 parts by weight or less, 99.6 parts by weight or less, 99.5 parts by weight or less, 99.4 parts by weight or less, or 99.3 parts by weight or less, based on a total weight of 100 parts of the positive-electrode active material, binder, and conductive material. The content of the binder is 0.1 parts by weight or more, 0.2 parts by weight or more, 0.3 parts by weight or more, 0.4 parts by weight or more, or 0.5 parts by weight or more, and is 10 parts by weight or less, 9.5 parts by weight or less, 9 parts by weight or less, 8.5 parts by weight or less, 8 parts by weight or less, or 7.5 parts by weight or less, based on a total weight of 100 parts by weight of the positive-electrode active material, binder, and conductive material.

The content of the conductive material is 0.01 parts by weight or more, 0.05 parts by weight or more, 0.1 parts by weight or more, 0.2 parts by weight or more, 0.3 parts by weight or more, 0.4 parts by weight or more, or 0.5 parts by weight or more, and is 10 parts by weight or less, 9.5 parts by weight or less, 9 parts by weight or less, 8.5 parts by weight or less, 8 parts by weight or less, or 7.5 parts by weight or less, based on a total weight of 100 parts of the positive-electrode active material, binder, and conductive material. The content of the positive-electrode active material, binder, and conductive material may be advantageous for improving the performance of the battery when adjusted within the aforementioned range.

In a positive electrode for an all-solid-state battery, the performance of the all-solid-state battery can be improved by adjusting the properties of the conductive material in consideration of the ratio of the conductive material to the positive-electrode active material. Accordingly, an embodiment of the present invention defines a new parameter B with respect to the conductive material and the positive-electrode active material. The value of B is determined by the following Equation 2.

$$B = R \times A \qquad Equation 2$$

Here, R is a value obtained by dividing the weight of the conductive material by the weight of the positive-electrode active material based on the positive-electrode, and A is a value calculated by Equation 1 mentioned above. Since the R value is the ratio of the equal unit weight of the conductive material and the positive-electrode active material, it has no units, and the A value, as described above, is also a numerical value without unit conversion. Accordingly, the B value also has no special unit. According to an embodiment of the present invention, the conductive material has a B value from 5 to 50. Specifically, the B value of the conductive material may be 5 or more, 6 or more, 7 or more, 8 or more, 9 or more, or 10 or more, and may be 50 or less, 46 or less, 42 or less, 38 or less, 34 or less, or 30 or less, and may be from 5 to 50, 8 to 38, or 10 to 30. The B value of the conductive material contributes to improving the performance of the all-solid-state battery by providing a criterion for appropriately endowing conductivity to the positive-electrode active material, which plays an important role in the performance such as the capacity of the all-solid-state battery. When the B value of the conductive material is adjusted within the aforementioned range, the conductive material may realize sufficient functionality in the positive electrode, which may be advantageous for improving the performance of the all-solid-state battery.

The positive-electrode active material, conductive material, binder, and inorganic solid electrolyte described above may be stacked on the collector to form a sheet-like positive-electrode active material layer. In the case of forming a positive-electrode active material layer on the collector, the positive electrode includes the collector and the positive-electrode active material layer. The collector is in contact with the positive-electrode active material layer over a larger area to effectively transfer electrons to the positive-electrode active material layer. The collector represents an electrically conductive material such as a metal plate, and depending on the polarity of the battery, electrodes known in the relevant technical field may be used as appropriate.

An aspect of the present invention provides an all-solid-state battery comprising a positive electrode for the all-solid-state battery. In constructing the above all-solid-state battery, a separate solid electrolyte layer may be introduced between the positive electrode and the negative electrode, and such a solid electrolyte layer may serve as a separator in a conventional lithium secondary battery. The batteries described above may in some cases be utilized as semi-solid batteries with a liquid electrolyte, in which a separate polymer separator may be required.

The polymer separator is interposed between the negative electrode and the positive electrode, and serves to electrically isolate the negative electrode and the positive electrode while allowing lithium ions to pass through. The polymeric separator may be any polymeric separator used in the conventional all-solid-state battery field, and is not particularly limited thereto.

The negative electrode corresponding to the positive electrode comprises a negative-electrode active material. The negative-electrode active material can be any material that can be used as a negative-electrode active material of a lithium-ion secondary battery. For example, the negative-electrode active material may be one or more selected from carbon such as hard carbon, graphitized carbon, or the like; metal complex oxides such as LiₓFe₂O₃ (0≤x≤1), LiₓWO₂ (0≤x≤1), SnₓMe₁₋ₓMe′_{y}O_{z} (Me: Mn, Fe, Pb, Ge; Me′: Al, B, P, Si, group 1, 2, 3 elements, halogens; 0<x≤1; 1≤y≤3; 1≤z≤8); lithium metals; lithium alloys; silicon-based alloys; tin-based alloys; metal oxides such as SnO, SnO₂, PbO, PbO₂, Pb₂O₃, Pb₃O₄, Sb₂O₃, Sb₂O₄, Sb₂O₅, GeO, GeO₂, Bi₂O₃, Bi₂O₄ and Bi₂O₅ and the like; conductive polymers such as polyacetylene; Li—Co—Ni based materials; titanium oxide; lithium titanium oxide and the like.

The negative electrode may be fabricated in the form of an anodeless battery in which no lithium is initially present. The anodeless battery does not contain lithium metal or lithium alloy, which can be a source of lithium for the negative-electrode active material, when the battery is first assembled. However, lithium may be precipitated inside the negative electrode during charging, allowing subsequent charging and discharging to occur. Therefore, the anodeless battery can have the negative-electrode active material located outside of the negative electrode. The initial layer of the negative-electrode active material does not contain lithium, and a carbon-based material, which allows the movement of lithium ions internally, can be used.

Depending on the type of negative-electrode active material, the negative electrode may include a conductive material and a binder, and the conductive material and binder used in the negative electrode may be any material that can be used as a conductive material and binder for a negative electrode of a lithium secondary battery in the relevant technical field. Specifically, it may be selected within the range of conductive materials and binders used in the positive electrode described above.

Configurations of the above all-solid-state battery that are not specifically disclosed in this disclosure are in accordance with methods commonly used in the relevant technical field.

An aspect of the present invention provides a battery module including the all-solid-state battery as a unit battery, a battery pack including the battery module, and a device including the battery pack as a power source.

Specific examples of such devices include, but are not limited to, a power tool powered by an electric motor; an electric vehicle, including an electric vehicle (EV), a hybrid electric vehicle (HEV), a plug-in hybrid electric vehicle (PHEV), and the like; an electric two-wheeler, including an electric bicycle (E-bike) and an electric scooter; an electric golf cart; and a power storage system.

Hereinafter, preferred embodiments are presented to facilitate the understanding of the present invention, but the following embodiments are provided only to facilitate the understanding of the present invention and are not limited to the present invention.

### EXAMPLES

### Composite Positive Electrode for an All-Solid-State Battery

### Example 1

A powder was fabricated by mixing LiNi_{0.8}Co_{0.1}Mn_{0.1}O₂(NCM 811) as the active material, a sulfide-based solid electrolyte (LPSCl) as the electrolyte, a fibrous carbon-based exemplary conductive material 1 (see Table 1 below) as the conductive material, in a weight ratio of 60:35:5. After weighing 1.2 g of the positive electrode material and 0.7 g of sulfide-based solid electrolyte in powder form, they were mixed using a agate mortar in a dry room environment for 15 minutes. Then 0.1 g of exemplary conductive material 1 was weighed and added to the above mixture and mixed for another 15 minutes to fabricate a composite positive electrode in the form of a mixed powder.

### Example 2

The composite positive electrode was fabricated in the same manner as in Example 1, except that exemplary conductive material 2 (see Table 1 below), a fibrous carbon-based conductive material, was used as the conductive material.

### Example 3

The composite positive electrode was fabricated in the same manner as in Example 1, except that exemplary conductive material 3 (see Table 1 below), a fibrous carbon-based conductive material, was used as the conductive material.

### Comparative Example 1

The composite positive electrode was fabricated in the same manner as in Example 1, except that comparative conductive material 1 (see Table 1 below), a particulate carbon-based conductive material, was used as the conductive material.

### Comparative Example 2

The composite positive electrode was fabricated in the same manner as in Example 1, except that comparative conductive material 2 (see Table 1 below), a particulate carbon-based conductive material, was used as the conductive material.

### Comparative Example 3

The composite positive electrode was fabricated in the same manner as in Example 1, except that comparative conductive material 3 (see Table 1 below), a particulate carbon-based conductive material, was used as the conductive material.

The exemplary and comparative conductive materials have the properties shown in Table 1 below.

TABLE 1

| | Exemplary | Exemplary | Exemplary | Comparative | Comparative | Comparative |
|---|---|---|---|---|---|---|
| | conductive | conductive | conductive | conductive | conductive | conductive |
| | material 1 | material 2 | material 3 | material 1 | material 2 | material 3 |
| BET Specific | 8.9 | 9.5 | 15 | 1300 | 386 | 9 |
| Surface Area | | | | | | |
| (m²/g) | | | | | | |
| Diameter (μm) | 0.31 | 0.30 | 0.15 | 0.034 | 0.035 | 0.28 |
| Length (μm) | 14 | 16 | 6 | — | — | — |
| Density (g/cm³) | 2.18 | 2.27 | 2 | 0.11 | 0.1 | 0.783 |
| Powder | 0.006 | 0.0016 | 0.017 | 0.04 | 0.022 | 0.164 |
| Resistivity | | | | | | |
| (ohm · cm) | | | | | | |
| A | 271.63 | 345.04 | 180.00 | 4.86 | 1.35 | 1.97 |
| B | 22.64 | 28.75 | 15.00 | 0.41 | 0.11 | 0.16 |

* BET specific surface area (m²/g): Measured with a BET specific surface area measuring device (Mfr.: Nippon Bell, product: BEL_SORP_MAX) after degassing at 200° C. for 8 hours and undergoing N₂ absorption/desorption at 77K.
* Diameter (μm): After fabrication of the fibrous conductive material and particulate conductive material, it is dispersed in an organic solvent, and optical images are taken and a particle image analyzer (Mfr.: Shimadzu, product: iSpect DIA-10) was used for a statistical measurement. The conductive material diameter is the average value after measuring the diameter of more than 100 conductive material fibers/particles in the images.
* Length (μm): After fabricating the fibrous conductive material, it is dispersed in an organic solvent, optical images are taken, and statistical measurements are made using a particle image analyzer. The conductive material length is the average value after measuring the diameter of more than 100 conductive material fibers/particles in the image.
* Density (g/cm³): Carbon-based conductive materials are measured with a pycnometer capable of measuring the density of a solid sample (Mfr.: Micromeritics, product: AccuPycII-1340). The density is measured by placing a sample of known weight in the sample chamber of the pycnometer and injecting helium or nitrogen gas to calculate the volume occupied by the sample.
* Powder resistivity (ohm · cm): The powder resistivity of a solid conductive material sample is measured with a powder resistivity meter (Mfr.: Hantech, product: HPRM-FA2). After attaching a lower punch to the body part of the powder resistor mold, the conductive material measurement sample of known weight is weighed. The upper punch is then attached and placed in the powder resistivity meter. Then the device is operated to pressurize from 0 to 2000 kgf in 400 kgf increments and observe the final resistivity at 2000 kgf (196 MPa).

Raman spectra and X-ray diffraction (XRD) before and after graphitization were analyzed for the above exemplary conductive materials and comparative conductive materials, and the resulting values are shown in Table 2 below.

TABLE 2

| | | Exemplary | Exemplary | Exemplary | Comparative | Comparative | Comparative |
|---|---|---|---|---|---|---|---|
| | | conductive | conductive | conductive | conductive | conductive | conductive |
| | | material 1 | material 2 | material 3 | material 1 | material 2 | material 3 |
| Raman | I_{D}/I_{G} before | 0.79 | 0.08 | 0.16 | 1.22 | 1.07 | 0.93 |
| data | graphitization | | | | | | |
| | I_{D}/I_{G} after | 0.3 | 0.08 | 0.12 | 0.69 | 0.65 | 0.18 |
| | graphitization | | | | | | |
| | Change of | −0.49 | 0 | −0.04 | −0.53 | −0.42 | −0.75 |
| | values before | | | | | | |
| | and after | | | | | | |
| | (Δ I_{D}/I_{G}) | | | | | | |
| XRD | d(002) before | 3.429 | 3.364 | 3.39 | 3.629 | 3.51 | 3.575 |
| Data | graphitization | | | | | | |
| | d(002) after | 3.406 | 3.371 | 3.397 | 3.464 | 3.447 | 3.424 |
| | graphitization | | | | | | |
| | DoG before | 12.5 | 87.9 | 58.6 | −219.8 | −81.5 | −156.5 |
| | graphitization | | | | | | |
| | DoG after | 39.5 | 80.2 | 50.2 | −28.2 | −7.8 | 18.6 |
| | graphitization | | | | | | |
| | Change of | 27 | −7.7 | −8.4 | 191.6 | 73.7 | 175.1 |
| | values before | | | | | | |
| | and after | | | | | | |
| | (ΔDoG) | | | | | | |

* Graphitization: After placing 10 g of carbon-based conductive material to be graphitized in a retort box inside the heating chamber of the graphitization furnace for carbon fiber (operating temperature: 2200~2800° C.), the temperature is increased to up to 2800° C. while injecting argon or nitrogen gas under vacuum conditions, and then cooled for more than 18 hours to obtain graphitized carbon-based conductive material. The rate of temperature increase was gradually reduced in each temperature coverage to prevent overheating and thermal runaway.
* I_{D}/I_{G}: Raman spectra were obtained for the surface of the samples with a 532 nm laser using a Raman spectroscopy apparatus (Mfr.: Jasco, product: NRS-2000B), and measured by analyzing the average spectra for 50 points. The value of I_{D}/I _{G} is the ratio of the intensity value of the peak in the absorption region of 1560 to 1580 cm⁻¹ (I_{G}) to the intensity value of the peak in the absorption region of 1320 to 1350 cm⁻¹ (I_{D}) obtained by Raman spectroscopy.
* Δ I_{D}/I_{G}: I_{D}/I_{G} after graphitization − I_{D}/I_{G} before graphitization
* Crystal plane d(002): the conductive material sample was attached to a low-background holder made of Si material on the XRD analysis device (Mfr.: Bruker, product: D8 Endeavor). The measurement was conducted in the 2theta range of 10-90 with a 0.014-degree interval, using FDS 0.3 deg, anti-scatter 3 mm, and 0.3 seconds exposure. The d(002) of the conductive material was calculated using the Bragg formula by obtaining the graph of 2theta values measured by XRD, and integrating the peak position on the graph through numerical methods as defined by Equation 3.
Equation 3
d(002) = λ/2sinθ
* Degree of Graphitization (DoG): An indicator of which material the crystal plane of the sample is closer to, the crystal plane spacing of ideal graphite (3.354 Å) and coal (3.440 Å). The DoG value is calculated by Equation 4 below.
[Equation 4]
DoG = (3.440 − d(002))/(3.440 − 3.354) × 100
* ΔDoG: DoG after graphitization − DoG before graphitization

### Experimental Example (Evaluation of Performance of Composite Positive Electrodes)

Using a pressure jig having a certain diameter, the mixed powder obtained in each of the embodiments and the comparative examples was pressurized and fabricated into a pellet form. The pellet was transferred to a pressure jig cell, and 200 mg of sulfide-based solid electrolyte powder was added to the pellet, and then pressurized with a force of 400 MPa for 60 seconds to form an electrolyte film. The Li metal negative electrode was then placed against the pellet and pressurized again at 100 MPa for 10 seconds to increase the electrolyte film-negative electrode contact. The rate characteristics were then observed in the charge/discharge tester after clamping the pressure jig cell.

To illustrate, charge/discharge was performed on an all-solid-state battery including each positive electrode fabricated in the examples and comparative examples, and the charge capacity (mAh/g), discharge capacity (mAh/g), and capacity retention (%) in the first cycle were measured and shown in Table 3 below. For the battery performance evaluation, the battery was subjected to the following charging/discharging conditions at a temperature of 60° C. and terminated in a discharged state (with no lithium on the negative electrode) (first charge/discharge test).
Charge conditions: 0.05 C, 4.25V CC/CV, 0.01 C cut-off
Discharge conditions: 0.05 C, 3V CC

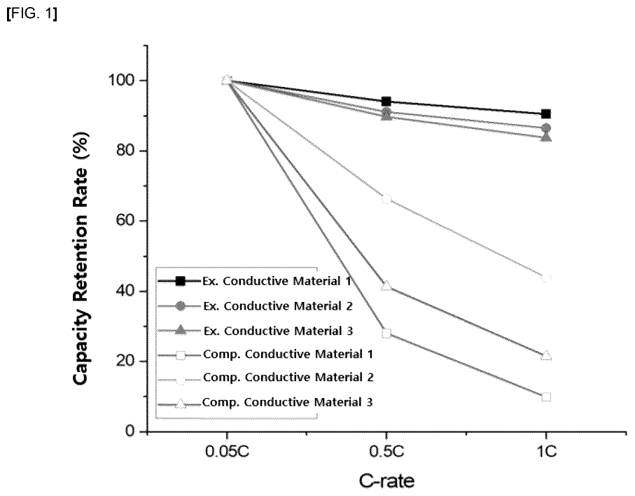

After the end of the first charge/discharge test, a second charge/discharge test was performed to measure the capacity retention rate (%) by charging under the same conditions as the first charge/discharge test, but the discharge was performed under the condition of 0.5 C and 3V CC. In addition, after the second charge/discharge test, the third charge/discharge test was performed under the same conditions as the first charge/discharge test, but the discharge was performed under the condition of 1 C, 3V CC to measure the capacity retention rate (%). The results of the second and third charge/discharge tests are shown in Table 3 and FIG. 1 below.

TABLE 3

| | | Exemplary | Exemplary | Exemplary | Comparative | Comparative | Comparative |
|---|---|---|---|---|---|---|---|
| | | conductive | conductive | conductive | conductive | conductive | conductive |
| | | material 1 | material 2 | material 3 | material 1 | material 2 | material 3 |
| First Charge/ | Initial charge | 250.44 | 228.26 | 239.78 | 263.98 | 258.44 | 218.74 |
| Discharge Test | capacity (mAh/g) | | | | | | |
| | Initial discharge | 234.01 | 209.31 | 220.28 | 209.49 | 210.12 | 186.7 |
| | capacity (mAh/g) | | | | | | |
| | Capacity | 93.43 | 91.68 | 91.87 | 79.36 | 81.31 | 85.35 |
| | retention (%) | | | | | | |
| Second Charge/ | Capacity | 94.06 | 91.12 | 89.72 | 28.03 | 66.38 | 41.34 |
| Discharge Test | retention (%) | | | | | | |
| Third Charge/ | Capacity | 90.47 | 86.51 | 83.72 | 9.91 | 44.02 | 21.54 |
| Discharge Test | retention (%) | | | | | | |

* Capacity retention (%) = (corresponding test discharge capacity/first discharge capacity) × 100

According to Table 3 above, the batteries using exemplary conductive materials 1 to 3, which have certain properties as fibrous carbon-based conductive materials, had better capacity retention than the batteries using comparative conductive materials 1 to 3, which have different properties as particulate carbon-based conductive materials. Furthermore, this difference in capacity retention was greater as the discharge rate increased, such as in the second and third charge/discharge tests. Batteries using exemplary conductive materials 1 to 3 had excellent rate characteristics, with no significant degradation in capacity retention at high rates.

In addition, among the fibrous carbon-based conductive materials, it has been confirmed that if a conductive material with a significant change in I_{D}/I_{G} value or DoG value beyond a certain level due to graphitization is used, superior rate characteristics are achieved, similar to exemplary conductive material 1.

All mere variations or modifications of the present invention fall within the scope of the present invention, and the specific scope of protection of the present invention will be made clear by the appended claims of the patent.

1. A positive electrode, comprising:
a positive-electrode active material,
a carbon-based conductive material, and
an inorganic solid electrolyte,
wherein the carbon-based conductive material is a fibrous carbon-based conductive material having a length from 1 μm to 100 μm.

2. The positive electrode of claim 1, wherein the carbon-based conductive material is a fibrous carbon-based conductive material having a diameter from 50 nm to 500 nm.

3. The positive electrode of claim 1, wherein the carbon-based conductive material has a BET specific surface area from 1 m²/g to 20 m²/g.

4. The positive electrode of claim 1, wherein a powder resistivity of the carbon-based conductive material is equal to or less than 0.025 ohm-cm under 196 MPa pressure.

5. The positive electrode of claim 1, wherein the carbon-based conductive material has a density from 1 g/cm³ to 5 g/cm³.

6. The positive electrode of claim 1, wherein the carbon-based conductive material has an A value from 100 to 500, wherein the A value is calculated by Equation 1:
$$A = specific surface area \times length \times density$$
wherein the specific surface area is a BET specific surface area of the conductive material (m²/g), the length is a length of the conductive material (μm), and the density is a density of the conductive material (g/cm³).

7. The positive electrode of claim 1, wherein the carbon-based conductive material has a difference of 0.3 to 0.7 in I_{D}/I_{G} values before and after graphitization in a Raman spectral analysis.

8. The positive electrode of claim 1, wherein the carbon-based conductive material has a difference of 10 to 50 in degree of graphitization (DoG) values before and after graphitization in an XRD analysis.

9. The positive electrode of claim 6, wherein the positive electrode has a B value from 5 to 50, wherein the B value is calculated by Equation 2:
$$B = R \times A$$
wherein R is a value obtained by dividing the weight of the conductive material by the weight of the positive-electrode active material based on the positive-electrode, and A is a value calculated by Equation 1.

10. The positive-electrode of claim 1, wherein the positive-electrode active material is selected from a group consisting of LiCoO₂, LiNiO₂, LiMnO₂, Li₂MnO₃, LiMn₂O₄, Li(NiₐCo_{b}Mn_{c})O₂ (0<a<1, 0<b<1, 0<c<1, a+b+c=1), LiNi_{1-y}Co_{y}O₂ (0<y<1), LiCo_{1-y}Mn_{y}O₂ (0<y<1), LiNi_{1-y}Mn_{y}O₂ (0<y<1), Li(NiₐCo_{b}Mn_{c})O₄ (0<a<2, 0<b<2, 0<c<2, a+b+c=2), LiMn_{2-z}Ni_{z}O₄ (0<z<2), LiMn_{2-z}Co_{z}O₄ (0<z<2), and combinations thereof.
